(19) United States
(12) Patent Application Publication
(10) Pub. No.: US 2007/0258119 A1
(43) Pub. Date: Nov. 8, 2007

(54) Optical Device, an Optical System and a Method of Manufacturing a Holographic Optical Element

(76) Inventors: Robert Adam Munday, Chertsey (GB); Paul Michael William French, Hersted Keynes (GB); Ollvier Pitavy, Richmond (GB)

Correspondence Address: Manelli Denison & Selter;Attn: William H. Bollman, 2000 M Street, NW, 7th Floor, Washington, DC, 20036, US

(21) Appl. No.: 11/631,894

(22) PCT Filed: Jul. 7, 2005
(86) PCT No.: PCT/GB05/02662

§ 371 Date: Feb. 5, 2007

(30) Foreign Application Priority Data
Jul. 7, 2004 (GB) 0415242.7

(51) Int. Cl. G03H 1/30; G03H 1/04

(52) U.S. Cl. 359/25; 359/1; 359/30

(57) ABSTRACT

This invention relates to an optical device and system for producing a holographic optical element or digital hologram. Various techniques of producing digital holograms have been proposed. However, they tend to suffer from long exposure times, as well as problems associated with control of two or more independent beams of coherent light used to produce a hologram. Problems become even more acute as pixel size decreases. The present invention provides an optical device including: a beam deflector, adapted to deflect a collimated beam of coherent light to produce an incident beam; a beam splitter for producing first and second beams, said beams being displaced so that the angle of deflection of the first beam is the same but opposite to the angle of deflection of the second beam; and a combiner combines the first and second beams so as to produce an interference pattern at an output plane.

### BACKGROUND

This invention relates to an optical device, an optical system and a method of manufacturing a holographic optical element.

More particularly, but not exclusively, the invention relates to a device and system, which is suitable for producing a holographic optical element, holographic micro-lens array, dot matrix hologram or digital hologram. A holographic optical element, holographic micro-lens array or dot matrix hologram is hereinafter referred to as a digital hologram.

Digital holograms have been fabricated since the early 1980's. Typically digital holograms comprise of a plurality of holographic lenses or pixels recorded in an array. Each micro-lens in the array is a small, single, diffractive or refractive, holographic optical element in its own right.

Digital holograms are recorded in the form of a two dimensional array which can have any pattern or layout. Each holographic micro-lens in the array redirects light that is transmitted through it (transmission hologram) or reflected off it (reflection hologram) to a particular position or viewing zone in space. The precise angle at which light is deflected, or reflected, from each holographic micro-lens—and hence the position of its viewing location in space—is pre-determined when the digital hologram is fabricated.

A digital hologram therefore is a complex holographic micro-lens array that can redirect incident light from a plurality of its constituent elements to a multitude of positions or viewing locations in space.

Various techniques of producing digital holograms have been proposed. Advantages of using digital techniques, over conventional analogue methods, are: firstly that production of the hologram is likely to be more controllable; and secondly production using digital techniques benefits from features and advantages often associated with digital systems.

One such feature is the ability to use information directly derived from, or stored on, a computer. However, a disadvantage of digitisation is that, because the printing of holographic micro-lenses has to be carried out sequentially, the time to record a digital hologram is very much greater than the exposure time of a conventional analogue hologram; all of which is recorded at once. However, despite the apparent drawback of longer overall exposure times, increasing effort is being made to produce digital holograms.

A problem with existing holographic equipment and systems, used to produce digital holograms, by way of interference of two or more light beams, has been the generation of, and subsequent control of, two or more independent beams of coherent light that are necessary to produce a holographic micro-lens. This problem becomes even more acute as pixel size decreases (a necessary requirement in order to produce higher resolution digital holograms), and micro-lens writing speeds increase (a necessary requirement in order to produce larger holograms within a practical time).

Creating and controlling two or more coherent beams of light is not in itself a problem and, for example, can be readily achieved using existing optical equipment, such as aperture masks, beam splitters and diffraction gratings. However, the problem of producing two or more beams, from the same source, and controlling them in a manner to produce holographic micro-lenses, at the dimensions and write speeds, necessary to achieve high resolution large area images, is a pronounced one.

### PRIOR ART

One of the most successful systems currently available is sold by Spatial Imaging Limited in the UK. The system sold by Spatial Imaging Limited is sold under the LIGHTGATE (Trademark). The system utilises a pair of rotating aperture masks to produce and manipulate two or more coherent laser beams, which are then focussed by means of lenses to produce the necessary interference in order to record a holographic micro-lens. The aperture masks are rotated independently of one another using high speed, brushless rotary servo motors.

Although the aforementioned system sold by Spatial Imaging Limited has been highly successful, there are limitations that arose mainly due to the speed of operation of the rotary servo motors.

UK Patent Application Number GB-A-1184309 (Agfa Gaevert) describes a system that employs a standard optical geometry for producing conventional holograms. The system includes a laser with little or no coherence length. Two beams are arranged in a standard holographic imaging camera. Provided the beam lengths are equal, it is possible to make holograms with low coherence laser beams.

European Patent Application Number EP-A-0534616 (Fujitsu) describes a simple dot matrix hologram system and how gratings are made.

U.S. Pat. No. 6,388,780 (Illinois Toll Works) describes an alternative high speed system for producing holograms. The system controls two laser beams independently of each other using two pairs of x-y scanners. Each beam is controlled separately. A disadvantage was that it was difficult to align the two beams and register the focal points.

Another piece of prior art which describes a device for manufacturing holograms is described in International Patent Application Number WO-A-2004/025379 (N-Line Corp). A simple beam splitter is described, which is used to combine two laser beams into one laser beam. The two beams are re-combined to lie in register with one another. The optical configuration is used to record a simple holographic interference pattern using a CCD chip. The device produces a low frequency holographic grating.

U.S. Pat. No. 3,936,139 (Thomson) describes a holographic data storage and replay device. It records a plurality of complex holograms of image data, created and displayed, by modulating radiation onto a stationary photosensitive plate using moving object and reference beams. A purpose of the device is to provide two coincident focused beams, one of which contains object data. Only one of the beams is capable, through the use of a complex array of optical components, of being moved across a stationary recording medium. Holograms recorded by this device are not simple diffraction gratings but contain object data. Also the recording beams are not symmetrical about a common axis. Furthermore the optical configuration, used in the device, is not able to manipulate the angle of both beams symmetrically relative to each other by virtue of the fact that the reference beam can only lie on a single plane. This is due to the fixed orientation of the holographic grating and the lenses employed.

An aim of the present invention is to provide a device, system and related method which overcomes the various problems and disadvantages associated with the above mentioned systems.

Another aim of the present invention is to provide a device, system and related method which is suitable for fabricating high quality, bright digital holograms and to produce these at a substantially increased write speed thereby reducing the time to fabricate digital holograms.

### SUMMARY OF THE INVENTION

According to one aspect of the present invention there is provided an optical device including a beam deflector, which, in use, is located at the focal point of a single incident beam of coherent light, characterised in that a beam splitter is provided to produce first and second beams, from the incident beam which beams are capable of being displaced about a principal optical axis, so that the angle of deflection of the first beam is the same but opposite to the angle of deflection of the second beam, and a combiner for combining the first and second beams.

According to another aspect of the present invention there is provided an optical device including: a beam deflector, which, in use, is adapted to deflect a substantially collimated beam of coherent light to produce an incident beam said deflection being in response to a control signal to the beam deflector; means for producing first and second beams that, in use, are capable of being displaced about a principal optical axis such that the angle of deflection of the first beam is the same but opposite to the angle of deflection of the second beam; and a combiner which combines the first and second beams so as to produce an interference pattern at an output plane.

Thus an advantage of the invention is that only a single beam has to be controlled and scanned with a single X-Y scanner. A further advantage is that the arrangement of optics automatically produces two perfectly symmetrical and convergent laser beams. Previously this has been difficult to achieve because it has proven difficult to maintain two, independently focused, beams in true and perfect alignment one with another.

Therefore a key advantage of this aspect of the invention is that registration and superimposition of the first and second beams at the output plane is relatively straightforward to achieve, when compared with prior art systems, because the first and second beams at the output plane remain collimated. Another advantage is that because the beam diameters are relatively large, typically of the order of 1-2 millimetres, they remain in register with one another.

To overcome any limitation in the spatial frequency range of the device, (arising as a result of the angle enclosed by the two beams) an image reduction system may be placed between the point at which the two output beams converge, and superimpose with each other, and the point at which the holographic image is to be recorded.

An advantage of this feature is that an image of a holographic pixel at the output plane, and its holographic grating can be reduced in size and therefore both the resolution of the hologram (in pixels per square millimetre) and the usable spatial frequency range may be increased. The consequence of this is that the quality of the final hologram is improved.

To overcome the latter limitation a mask may be suitably positioned at the output plane and dimensioned to define an aperture for forming a pixel from two beams, which in operation, are in registration and superimposed, one with another. Ideally the mask is perpendicular with the optical axis and defines a tessellating shaped aperture. Because the beams are confined by the mask, and due to the fact that they are in registration and superimposed one with another as they pass through the mask, the combined interfering beams have identical characteristics due to the screening effect of the mask. The result is a bright, high quality hologram comprising shaped pixels, which substantially cover the entire holographic supporting surface.

Ideally the mask has two sets of substantially parallel sides that are most preferably all the same length and arranged at right angles, so as to define a suitably shaped aperture that produces square shaped pixels. However, it will be appreciated that triangular or indeed any other shaped pixel may be formed by the mask. In an alternative embodiment even a letter or sequentially varying shaped pixel may be used for the purposes of producing a secure hologram in which is encoded or embedded a unique identifier, such as a watermark label.

Such a sequentially varying or alternating mask may comprise a ferroelectric device or spatial light modulator (SLM), which is addressable electronically in order to alter its shape and dimensions in real time. Therefore optical encoding of information, such as security data, into a hologram at the microscopic level, is achievable under direct control of software for example; such data being difficult to reproduce as it is not only extremely small, but can also be encrypted.

According to a third aspect of the invention there is provided an optical device including: a beam deflector, which in use is adapted to deflect a substantially collimated beam of coherent light to produce an incident beam; means for producing first and second beams of substantially equal length and being substantially symmetric to each other which, in use, are capable of being displaced about a principal optical axis such that the angle of deflection of the first beam is the same but opposite to the angle of deflection of the second beam; and a combiner which combines the first and second beams so as to produce an interference pattern at an output plane.

An optical device including, a beam deflector, which in use is adapted to deflect a substantially collimated beam of coherent light to produce an incident beam; means for producing first and second beams which, in use, are capable of being displaced about a principal optical axis such that the angle of deflection of the first beam is the same but opposite to the angle of deflection of the second beam; and a combiner which combines the first and second beams so as to produce an interference pattern at an output plane, said pattern being capable of recording a hologram comprising simple diffraction gratings.

The above mentioned optical devices are hereinafter referred to as scanning interferometers. Because it is envisaged to fabricate the optical device as a stand alone system, it may be retrofitted to an existing optical system. Suitable software may also be provided to enable exiting systems to be modified to operate with the device.

Preferably the scanning interferometer comprises: a beam splitter and beam combiner configuration arranged, whereby in use, a collimated (or near collimated beam) beam of coherent light is split to produce first and second beams, using a first beam splitter, the first and second beams pass through a lens system before they are recombined by a second beam splitter.

In a particularly preferred embodiment it will be appreciated that the beams may be split and combined by a single beam splitter.

Ideally the optical device may include a beam splitter for splitting an incident beam into first and second beams; a first lens arrangement, located intermediate the beam splitter and a first mirror, through which first lens arrangement the first beam passes, the first mirror being arranged to reflect the first beam to the beam splitter; and a second lens arrangement, located intermediate the beam splitter and a second mirror, through which second lens arrangement the second beam passes, the second mirror arranged to reflect the second beam to the beam splitter.

An advantage of this embodiment is that mirrors help to lengthen the effective path lengths. Consequently as the beams pass through the same lenses effectively twice, less optical components are used and the system achieves the same result as before but is both smaller and cheaper. This feature may be included in both a focused and a collimated system.

Conveniently the beam splitter and beam combiner are 50% beam splitters; thereby the intensity of each beam is the same. However, situations may be envisaged where there is a non-equal split of beam intensity or the intensity of each beam varies during an exposure.

An advantage of the scanning interferometer is that two coherent beams are produced, and displacement of the first beam from the principal axis is exactly replicated by displacement of the second beam. As the angle of deflection, in both x-z and y-z planes, from the principal optical axis is identical in both beams, any rotation (Ø), of the beams about the principal optical axis, also occurs simultaneously. Thus the beams are easier to manipulate and control.

Preferably means is provided to vary the diameter of the collimated beam. A reducing/enlarging lens arrangement is ideally adapted to vary the beam diameter. An advantage of this feature is that the mask aperture can be filled with a uniform intensity of light. This provides more consistent quality pixels which diffract light uniformly and at the same intensity across their entire surface, thus a superior quality hologram is obtained.

In a preferred arrangement a pixel size of less than 30 μm×30 μm is achieved. Ideally the pixel size is less than 20 μm×20 μm and most preferably it is less than 10 μm×10 μm. The fact that the size of the point at which the two beams converge can be reduced or enlarged is considered to be particularly advantageous as it permits a variable pixel size to be produced.

Advantages of the above mentioned embodiments, in digital holography, are that two exactly identical beams are produced whose characteristics can be manipulated simultaneously. Under control of suitable software, coherent light beams can be displaced controllably and rapidly whilst registering and superimposing them at a common output point.

Ideally beams are displaced to different positions, relative to the optical axis, in order to produce a desired holographic grating. This is one factor that relates the speed of manipulation of the two beams to the speed of exposure. The amount and speed of displacement is typically measured as pixels per second or exposures per second. In this sense the beams can be displaced typically at a rate of 0.2 kHz to 2 kHz and ideally in excess of 5 kHz using certain optical beam deflectors or scanners. Digital hologram recording times are therefore greatly reduced.

It will be appreciated that the invention, under control of a controller, for example a microprocessor, is capable of producing a pair of superimposed beams. Moreover as the two beams emanate from a common source they are absolutely identical in every respect (including coherence and polarisation). Furthermore the two beams may be manipulated i.e. displaced laterally in both the x-z and y-z planes and can therefore effectively be rotated about the principal optical axis, by an angle (Ø) at very high speeds and with accuracy and precision.

An acousto-optic modulator (AOM) may be used as a beam deflector. An advantage of an acousto-optic beam deflector is that it can be operated at high frequencies, typically in excess of 5 kHz, and preferably in excess of 10 kHz, thereby enabling holographic production rates to be further increased. An alternative beam deflector utilises a piezoelectric (PZ) element. A further alternative beam deflector is a galvanometric beam deflector and is typically capable of exposing 3000 points per second.

According to another aspect the invention provides a method of producing a holographic optical element comprising the steps of: deflecting a single coherent and collimated (or near collimated) beam in dependence upon a control signal to a beam splitter; producing first and second light beams from said deflected beam; directing said first and second beams to first and second lens arrangements, the first and second beams produced being capable of being displaced about a principal optical axis so that the angle of deflection of the first beam (θ1) is the same as, but opposite to, the angle of deflection as the second beam (θ2); and causing the beams to superimpose in order to create holographic interference fringes at an output plane.

An image reduction system may be placed between the point at which the two output beams converge and superimpose with each other (at the output plane or the object) and the point at which the holographic image is to be recorded (the image). An advantage of this is that the recorded holographic pixel and its holographic grating can be reduced in size and therefore both the resolution of the hologram (in pixels per mm) and the usable spatial frequency range is increased. The consequence of this is that the quality of the final hologram is improved.

According to a yet further aspect of the invention there is provided a hologram produced by deflecting a single collimated (or near collimated) coherent beam; producing first and second collimated beams from said deflected beam; directing said first and second beams to first and second lens arrangements, the first and second beams being displaced about a principal optical axis so that the angle of deflection of the first beam (θ1) is the same as, but opposite to, the angle of deflection of the second beam (θ2); and causing the beams to interfere in order to create holographic interference fringes at an output plane.

In all the abovementioned aspects it will be understood that the purpose of the scanning interferometer is to deflect the first beam through an angle (θ1) in an opposite sense, about the principal optical axis, to the angle of deflection of the second beam (θ2).

Variations to the system may be made as understood by the skilled person. For example a pulsed or other intense laser may be incorporated to enable the ablation of gratings/pixels in a substrate, such as a metal substrate. Such an ablated metal substrate may be used for direct printing of holograms or it may be used as part of a moulding process for producing holograms by a printing or injection moulding process, for example for forming holograms, in a synthetic plastics substrate.

Preferred embodiments of the invention will now be described, by way of exemplary examples only, and with reference to the accompanying Figures in which:

### BRIEF DESCRIPTION OF THE FIGURES

FIG. 1 shows a diagrammatical overview of an optical system which produces focussed output beams suitable for the production of digital holograms;

FIG. 2 shows an equivalent ray diagram of the device shown in FIG. 1;

FIG. 3 are an alternative embodiment of the system shown in FIG. 1;

FIG. 4 shows an equivalent ray diagram of the device shown in FIG. 3;

FIG. 5 shows a diagrammatical overview of an alternative embodiment of an optical system, which produces collimated output beams suitable for the production of digital holograms;

FIG. 6 shows an equivalent ray diagram of the system shown in FIG. 5;

FIG. 7 is an alternative embodiment of the system shown in FIG. 5;

FIG. 8 is a further alternative embodiment of the system shown in FIG. 5;

FIG. 9 is a further alternative embodiment of an optical system which produces focussed output beams suitable for the production of digital holograms;

FIG. 10 shows an equivalent ray diagram of the device shown in FIG. 9;

FIG. 11 is a further alternative embodiment of a device for use in a collimated system which produces focussed output beams suitable for the production of digital holograms;

FIG. 12 shows an equivalent ray diagram of the device shown in FIG. 11;

### DETAILED DESCRIPTION OF PREFERRED EMBODIMENTS OF THE INVENTION

Referring to the Figures generally, in which like parts bear the same reference numerals, there is shown a device 10 incorporated in an optical system 100 for producing a hologram (not shown) at an output plane 200. The output plane 200 may be located at either of two positions 200a or 200b in dependence upon whether an image reduction device is included.

The optical system 100 includes a modulated laser 60 for producing a coherent light beam 12 and a scanner 30 for deflecting the light beam 12 in accordance with control signals from a controller. A photoresist coated plate or other holographic supporting medium is located at the output plane 200a or 200b and it is here where the hologram is formed. The photoresist coated plate is typically supported so that relative displacement is achieved between the system and the photoresist coated plate (or other holographic supporting medium), so that pixels can be defined at different locations on the photoresist coated plate.

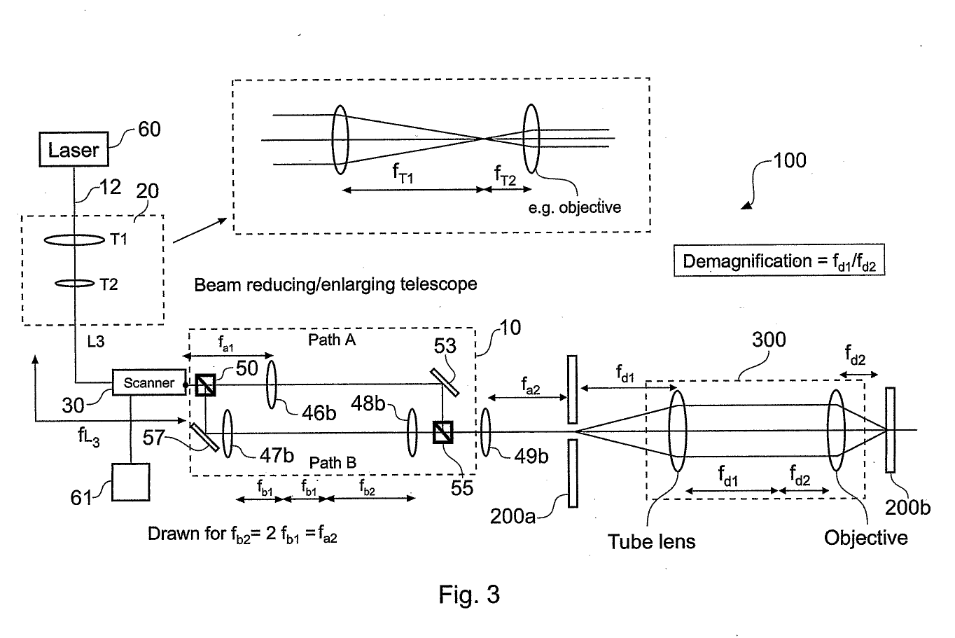

The embodiment shown in FIG. 3 includes a beam reducing/enlarging lens arrangement 20. The lens arrangement 20 is used to precondition the beam 12 prior to it being scanned by scanner 30. Preconditioning of beam 12 is carried out in order to vary the diameter of beam 12 that is incident on scanner 30.

Scanner 30 is of the type that includes a beam deflector (not shown). The beam deflector may comprise a piezoelectric (PZ) element, an acousto-optic device (AOD) or a galvanometric beam deflector.

Light beam 12 passes to scanner 30 where it is deflected, as a result of controlled movement of a mirror in the scanner 30, along x and y axes in accordance with signals received from a controller 60. The mirror on the scanner alters the angle of incidence of the laser beam 12 to optical device 10 in both x and y directions. Beam 12 is split by beam splitter 50 into a first beam 12A and a second beam 12B. Mirrors 33 and 34 direct beams 12A and 12B respectively.

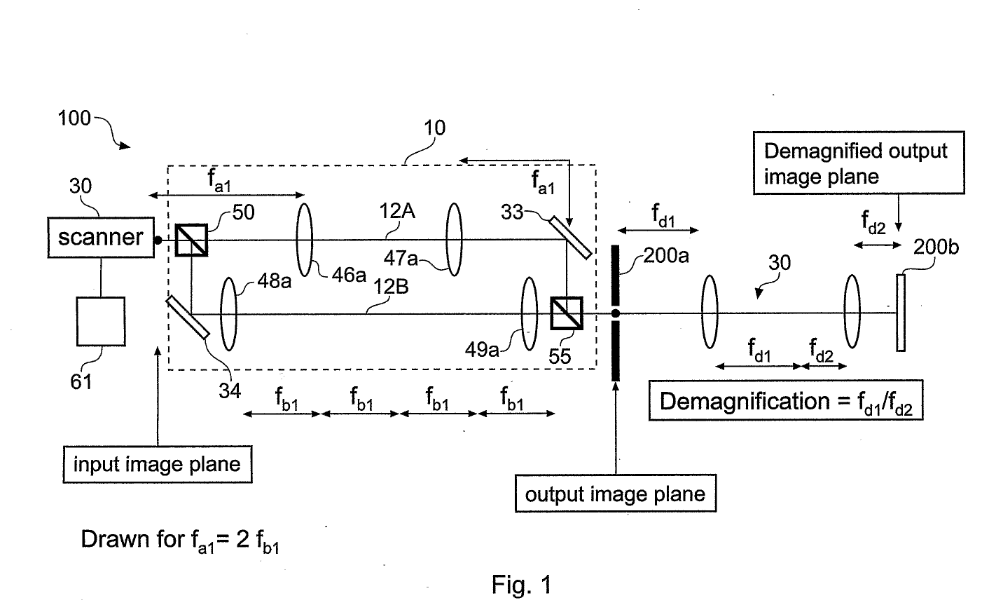

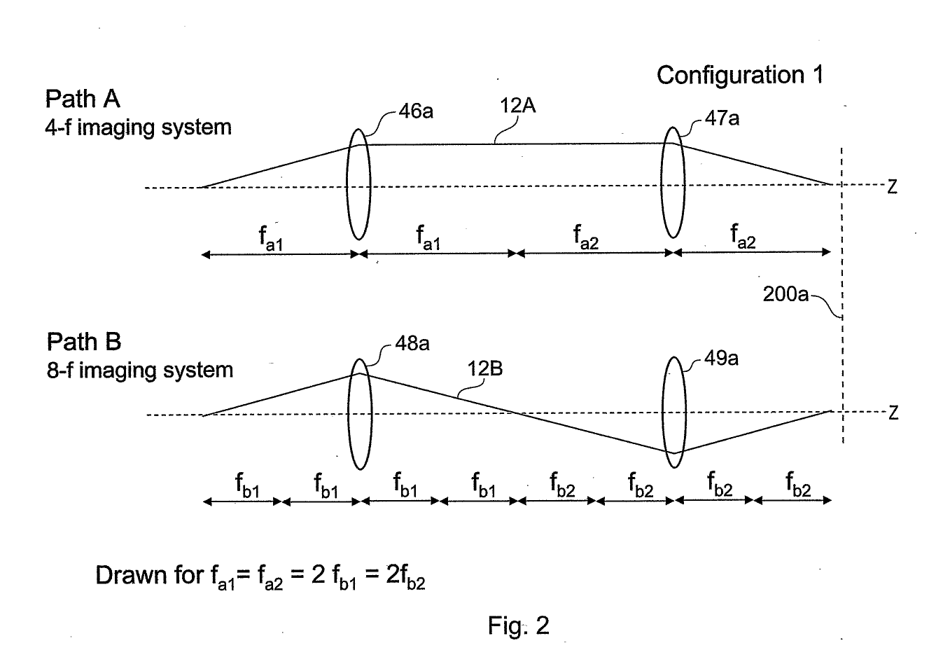

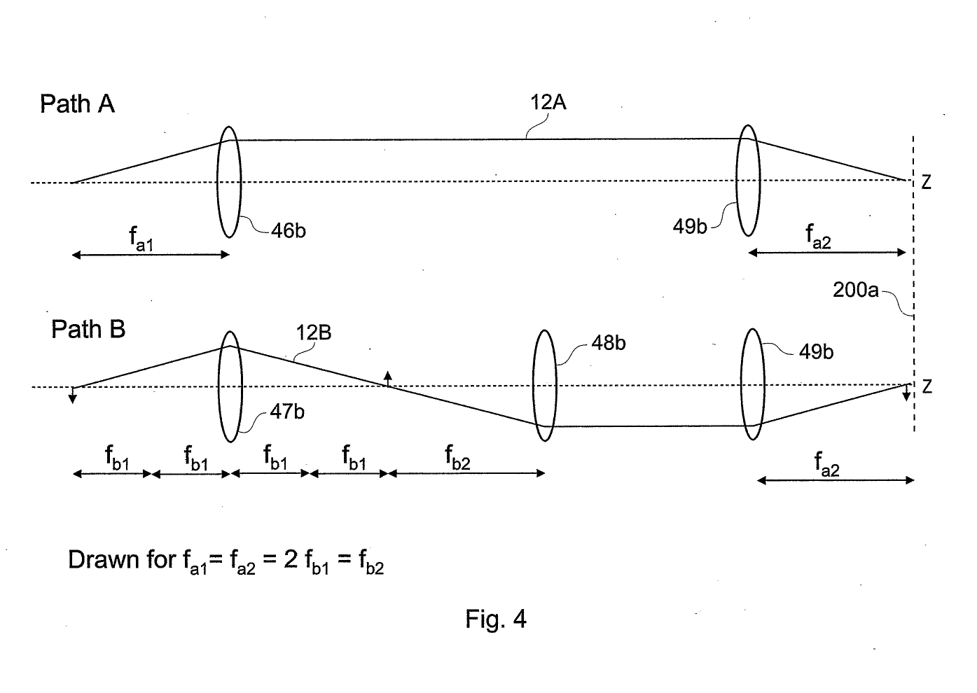

FIGS. 2 and 4 show ray diagrams of lens configurations 46a, 47a, 48a and 49a and 46b, 47b, 48b and 49b used in the optical device 10 shown in FIGS. 1 and 3 respectively.

FIGS. 2 and 4 show how the beam 12 of incident light is split into first 12A and second 12B beams and respective lens arrangements 46a, 47a, 48a and 49a and 46b, 47b, 48b and 49b modify the beams 12A and 12B. The two beams 12A and 12B are depicted passing through separate optical elements and lens trains. The lens trains or lens arrangements and operation of the lenses are described in greater detail below.

Referring to FIG. 3 the particular orientation of beam splitter 50, lenses 46a, 47a, 48a and 49a and beam combiner 55 in the optical device 10; their relative position one to another and the focal lengths of the lenses 46a, 47a, 48a and 49a ensure that the angle of deflection (θ1) of the first beam 12A is the same as, but opposite to, the angle of deflection (θ2) of the second beam 12B. This configuration ensures that two exactly identical beams are produced and that the displacement of beam 12A is faithfully reproduced, but in an opposite sense, by beam 12B.

In the embodiment of the optical device 10, shown incorporated as part of a system 100, in FIG. 3, light beam 12 optionally passes through a lens arrangement 20 that acts as a beam reducer or enlarger. Lens arrangement 20 is, for example, a series of co-linear focussing lenses. The optical device 10 produces a pair of optically identical beams 12A and 12B in a manner similar to the device 10 shown in FIG. 1.

The optical device 10 shown in FIG. 3 also has four lenses 46b, 47b, 48b and 50b, as well as two mirrors 53 and 57; otherwise like parts bear the same reference numerals as in FIG. 1.

The arrangements of lenses and mirrors depicted in FIGS. 1 and 3 may be referred to as scanning interferometer because the arrangement produces two focussed output beams that converge symmetrically about a principal optical axis (PA). For convenience the principal optical axis is the z-axis.

In the embodiment shown in FIG. 3 the optical device 10 comprises: a beam splitter 50, a lens system, first and second mirrors 53 and 57 and a beam combiner 55. Scanner 30, in use, is located at the focal point of the single incident beam of coherent light. Beam splitter 50 produces first 12A and second 12B beams, from the incident beam 12, which first and second beams 12A and 12B are capable of being displaced about the principal optical axis. This occurs as a result of the relationship between the lenses (shown in detail in FIG. 4). Beam combiner 55 for combining the first and second beams. The beams are then focussed to a common point in an output plane by the lenses.

The optical device 10 may be retrofitted to an existing optical system 100. Suitable software may also be provided to enable exiting systems 100 to be modified to operate with the device.

It will be appreciated that modification of the system 100 to receive the optical device 10, may be required. For example, the optical device shown in FIG. 1 has four lenses 46a, 47a, 48a and 50a, whose focal length relationship and ratios differ from the four lenses 46b, 47b, 48b and 50b in the device 10 shown in FIG. 3.

FIG. 4 is a ray diagram and illustrates in detail the focal lengths of four lenses 46b, 47b, 48b and 49b and how beams 12A and 12B are refracted to a common point at output plane 200a or 200b.

Image reduction device 300 is optional and comprises two lenses and is used to focus beams 12A and 12B from output plane 200a to an alternative output plane 200b.

It will be appreciated therefore that use of the optical device 10 enables the production of high quality digital holograms to be fabricated faster than has previously been achievable. Moreover as the device can be retrofitted to existing holographic fabrication systems 100, under supervision of suitable control software and hardware. It will be further appreciated that the invention provides a relatively cheap way of upgrading existing systems to provide superior quality holographic production systems.

It will also be appreciated that control hardware and software, as well as data carriers supporting said software, for use with the aforementioned device 10 and/or system 100, falls within the scope of the invention.

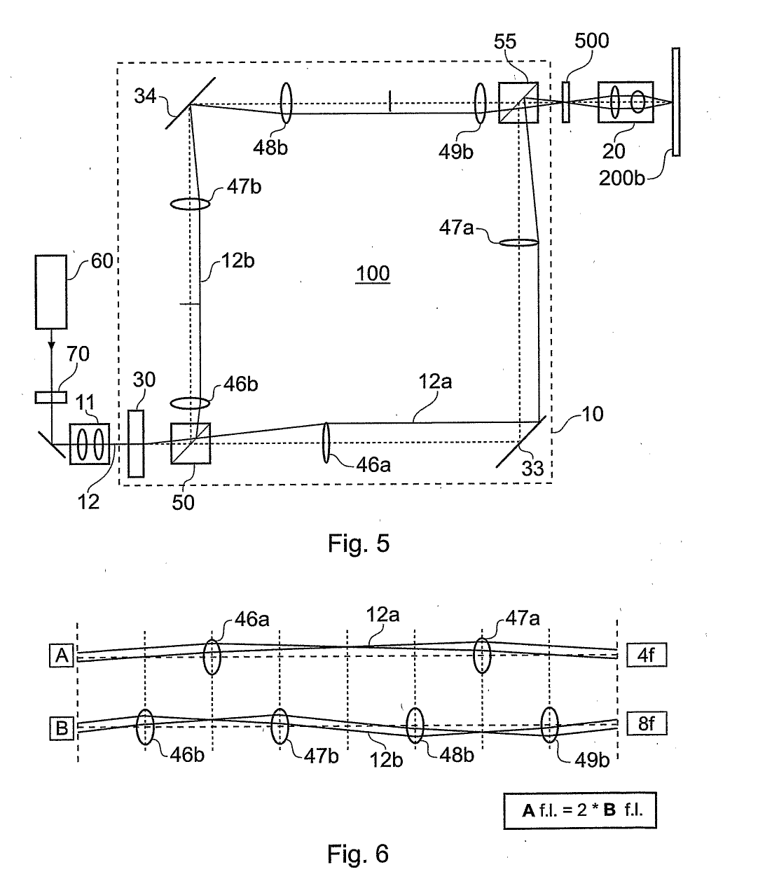

Reference will now be made to alternative embodiments described with reference to FIGS. 5, 7, 8, 11 and 12. The embodiments overcome problems associated with, for example, focussed output beam systems as incorporated in the systems shown in FIGS. 1 to 4. The systems shown in FIGS. 1 to 4 produce a pair of twin beams whose focal points were substantially in registration, in such a way that they both focussed to substantially the same position in the output plane. A practical limitation of this was that during rotation of the two beams there were occasions when they were not in registration with one another.

Furthermore a system employing the device described with reference to FIGS. 1 to 4 suffered also from a limited spatial frequency range. That is to say, the number of interference fringes per pixel was limited and this restricted the type of holograms and holographic effects that could be produced. The spatial frequency range is a function of the angle between the two beams and is determined by the focal length and diameter of the lenses. In turn, this limited the range of angles through which the scanner was capable of scanning. Therefore the quality of final images was sometimes compromised.

One way of increasing the spatial frequency range was to use image reduction optics. However, this proved impractical, however due to the fact that the pixels, which were already typically of the order of 20-100 microns in diameter, were reduced in size still further by the image reduction lens optics 300. An advantage of using such image reduction optics extends the available spatial frequency range, it further reduces the size of twin focal points. However, this has meant that it was more difficult for the two beams to register and superimpose, one with the other.

Furthermore because the output focal points were small, it was difficult to provide specific shaped pixels, so as to improve coverage of photosensitive material (on which the hologram was formed) and therefore overall image brightness could not always be optimised.

The alternative embodiments, described with reference to FIGS. 5, 7, 8, 11 and 12, arose in an order to produce an optical device, which, in one embodiment, is suitable for incorporation into an existing optical system, with the advantages of a digital address and write capability.

Referring to further embodiments, in which like parts bear the same reference numerals as in FIGS. 1 to 4, the embodiments depicted in FIGS. 5, 7, 8, 11 12, show an optical device 10 and optical system 100. System 100 includes a laser 60 for producing a collimated (or near collimated) beam of coherent light 12, a shutter 70 to modulate the beam, a reducing/enlarging lens arrangement 11 and a beam deflector 30 for scanning the light beam 12.

A mask 500 is placed at an output plane 200a of the optical system 100. A resist or other holographic supporting medium is located at the output plane 200b. An image relay system, which preferably is used as an image reduction system 20, is also present; the purpose of the image relay or image reduction system 20 is explained below.

The lens arrangement 11 is used to condition beam 12 in order to vary the beam diameter so as to give an even intensity of light across the aperture mask 500. An x-y beam deflector 30 typically comprises a piezoelectric (PZ) element, an acousto optic device (AOD) or a galvanometric beam deflector. The beam 12 is split by a beam splitter 50 into two beams 12a and 12b. Mirrors 33 and 34 direct beams 12A and 12B respectively.

Light beam 12 passes to the beam deflector 30 where it is deflected along x and y axes in both x-z (θ1) and y-z planes (θ2) in accordance with control signals received from a controller (not shown).

An image relay system 20, which may preferably be an image reduction system (although may be used as an image enlargement system), is positioned between aperture mask 500 and recording plane 200b, to relay and preferably reduce, an image of the aperture mask onto the recording plane 200b.

FIG. 6 shows a ray diagram of lens configurations 46a, 47a, 48a and 49a and 46b, 47b, 48b and 49b used in the optical device 10 shown in FIGS. 4, 7 and 8 respectively.

FIG. 6 shows how the beam 12 of incident light is split into first 12A and second 12B beam paths and how respective lens arrangements 46a and 47a; and 46b, 47b, 48b and 49b modify the beams 12a and 12b. The two paths 12A and 12B are depicted passing through separate optical elements and lens trains.

Referring again to FIG. 6 the particular orientation of lenses 46a and 47a and lenses 46b, 47b, 48b and 49b; their relative position one to another; and their focal lengths, ensure that the angle of deflection of the first beam 12A is the same but opposite to the angle of deflection of the second beam 12B. This configuration ensures that two exactly identical beams are produced and that the displacement of beam 12A is faithfully reproduced, but in an opposite sense, by beam 12B. It also ensures that both the single input beam 12 and the two output beams are collimated (or near collimated) at both the input plane and the output plane.

The device 10 described above and shown in FIGS. 5, 7, 8, 11 and 12 may be referred to as a scanning interferometer 10 and, in use, produces two collimated output beams that converge symmetrically about the principal optical axis (PA) at the output plane. For convenience the principal optical axis is the z-axis and is shown as dotted lines in FIGS. 5 to 8.

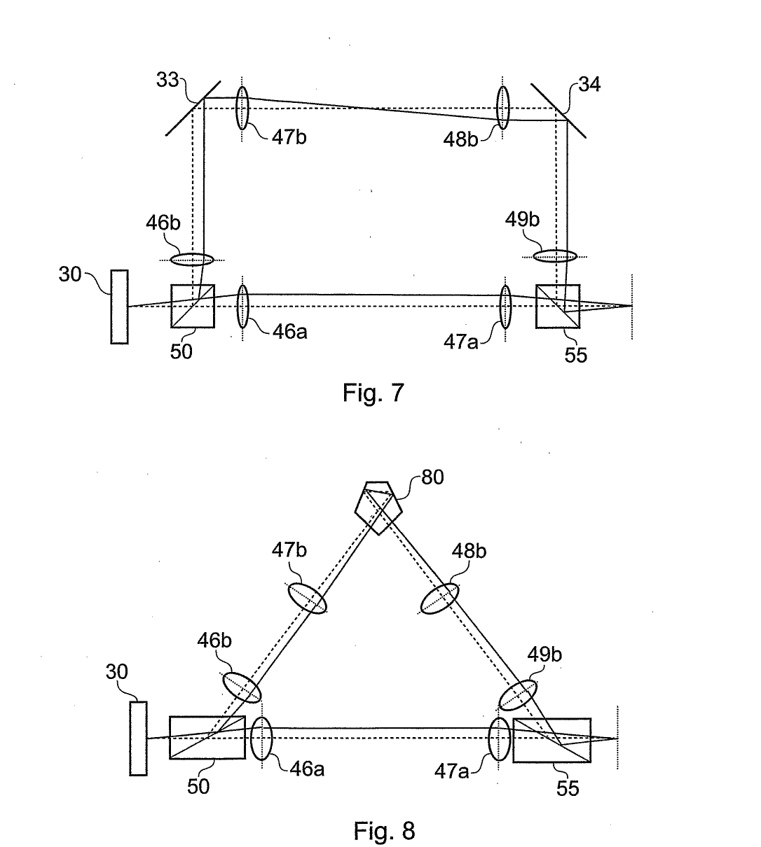

In the embodiment shown in FIG. 7, in which the beams 12A and 12B have different path lengths, the optical device 10 comprises: a beam splitter 50, lens systems 46a, 47a and 46b, 47b, 48b and 49b, first and second mirrors 33 and 34 and a beam combiner 55. Beam splitter 50, in use, is located so as to split beam 12 into two collimated beams of coherent light. The optical device 10 produces first and second beams, from the incident beam, which are capable of being displaced about the principal optical axis (OA). Combiner 55 combines the first and second beams so that they interfere at a common point at or near the output mask 500 in the output plane 200a.

The embodiment shown in FIG. 8, (similarly has different beam path lengths), in which like parts bear the same reference numerals, shows a system that utilises a pentaprism 80 instead of mirrors 33 and 34. A practical advantage is that the further miniaturise the scanning interferometer. Again beam 12, which is deflected by a relatively small angle from the principal optical axis, is split by a beam splitter 50 into two beams that pass along first 12A and second 12B paths.

The optical device described above may be retro-fitted to an existing optical system. Suitable software may also be provided to enable exiting systems to be modified to operate with the device.

It will be appreciated that modification of the system 100 may be required to receive the optical device 10, shown in either FIGS. 5, 7, 8, 11 and 12, may be required. For example, the optical configuration of system 100 may need to be altered.

Imaging relay or reduction/enlargement device 20 comprises two (or more) lenses 24 and 26 and is used to relay and preferably reduce an image of the two coinciding beams and the aperture mask 500 to an alternative output plane 200b.

Use of the optical device 10 therefore enables the production of high quality digital holograms to be fabricated faster than has previously been achievable. Moreover as the device can be retrofitted to existing holographic fabrication systems, under supervision of suitable control software and hardware, it will be further appreciated that the invention provides a relatively cheap way of upgrading existing systems to provide superior quality holographic production systems.

FIGS. 7, 8, 11 and 12 show alternative embodiments of lens configurations that may be used to produce two coherent beams from a single source and maintain the beams in a collimated condition as described above.

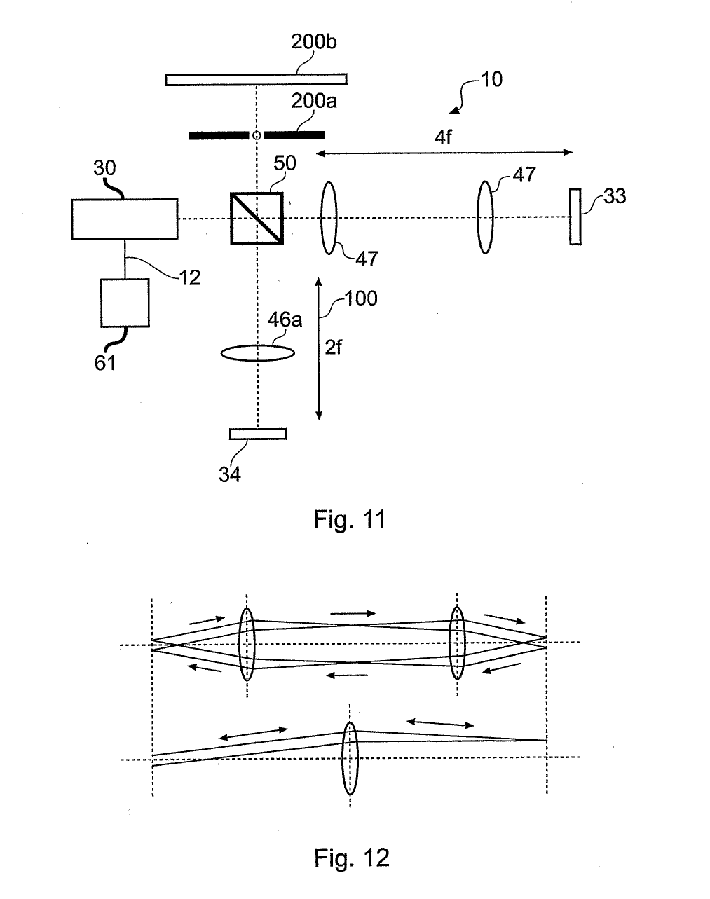

FIGS. 11 and 12 show a sketch of an equivalent optical device, which is more compact than the other embodiments. As the device shown in FIGS. 11 and 12 has less lenses and other optical devices the system is cheaper to manufacture than the alternative embodiments. Also because beams pass through less optics it is also less prone to producing aberrations in the final holograms. Also, again as a result of the relatively simple arrangement of lenses, alignment of the device is more straightforward.

Referring to FIGS. 11 and 12, in which like parts bear the same reference numerals as the other Figures, there is shown a device 10 for producing a hologram (not shown) either at an output plane 200a or 200b. A laser 60 produces a coherent light beam 12. Beam 12 is directed to a scanner 30 that scans the light beam 12 to a beam splitter 50 which produces two beams 12A and 12B. Other optical elements and lenses 46, 47 and 48 are similar to the configuration described earlier. Mirrors 33 and 34 help to define path lengths because the distances between the beam splitter and each mirror is effectively doubled. Consequently as the beams pass through the same lenses twice, less optical components are used and the system achieves the same result as before but is both smaller and cheaper.

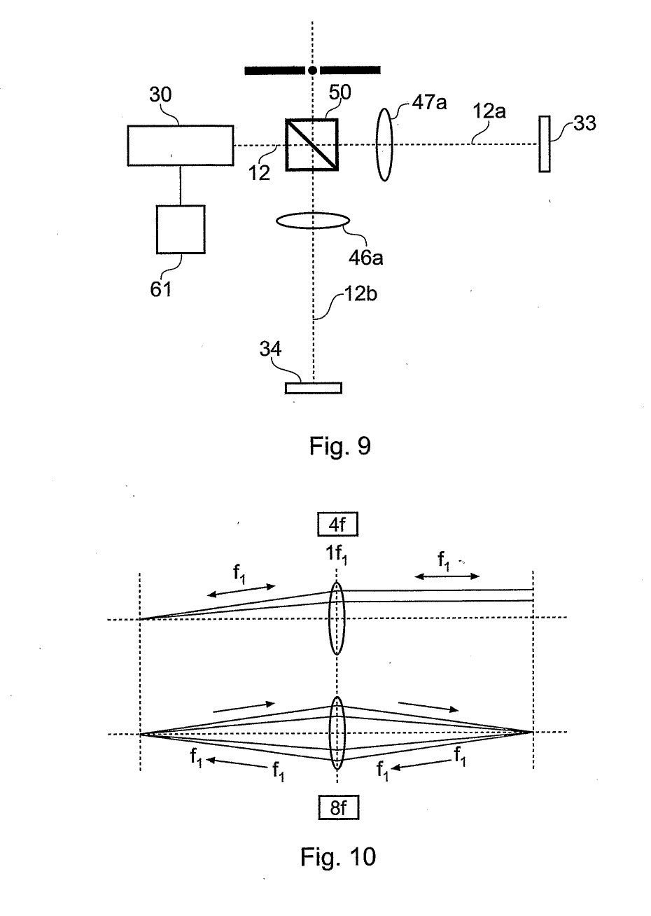

FIGS. 9 and 10 show a further alternative embodiment of an optical system which produces focussed output beams, suitable for the production of digital holograms. The system incorporates two mirrors 33 and 34 arranged to double the effective path lengths of beams 12A and 12B in focussed beam configuration. Like parts bear the same reference numerals as the other Figures.

Other variations may be made to the invention, for example and without limitation, a laser may be arranged to ablate a holographic optical element. A high energy, short pulsed laser may be employed to ablate small regions of metal or other substrate. The duty cycle of such lasers may be only for a few Femto seconds as only a small volume of material needs to be removed at each pulse. Such substrates may be supported on rollers or other formation devices and may be of the type used in industrial moulding systems for producing individual holograms, for example on credit cards, polyester films or packaging.

The invention has been described by way of examples only and it will be appreciated that variation may be made to the embodiments described without departing from the scope of the invention.

1. An optical device including a beam deflector, which, in use, is located at the focal point of a single incident beam of coherent light, wherein:
a beam splitter is provided to produce first and second beams, from the incident beam which beams are capable of being displaced about a principal optical axis, so that the angle of deflection of the first beam is the same but opposite to the angle of deflection of the second beam, and a combiner for combining the first and second beams.

2. An optical device includes:
a beam deflector, which in use is adapted to deflect a substantially collimated beam of coherent light to produce an incident beam said deflection being in response to a control signal to the beam deflector;
means for producing first and second beams, in use, are capable of being displaced about a principal optical axis such that the angle of deflection of the first beam is the same but opposite to the angle of deflection of the second beam; and
a combiner which combines the first and second beams so as to produce an interference pattern at an output plane.

3. An optical device including,
a beam deflector, which in use is adapted to deflect a substantially collimated beam of coherent light to produce an incident beam;
means for producing first and second beams of substantially equal length and being substantially symmetrical to each other which, in use, are capable of being displaced about a principal optical axis such that the angle of deflection of the first beam is the same but opposite to the angle of deflection of the second beam; and
a combiner which combines the first and second beams so as to produce an interference pattern at an output plane.

4. An optical device including,
a beam deflector, which in use is adapted to deflect a substantially collimated beam of coherent light to produce an incident beam;
means for producing first and second beams which, in use, are capable of being displaced about a principal optical axis such that the angle of deflection of the first beam is the same but opposite to the angle of deflection of the second beam; and
a combiner which combines the first and second beams so as to produce an interference pattern at an output plane, said pattern being capable of recording a hologram comprising simple diffraction gratings.

5. An optical device according to claim 2 comprising:
first and second lens arrangement adapted so that, in use, the angle of deflection (θ1) of the first beam, passing through the first lens arrangement, is in an opposite sense, about the principal optical axis, to the angle of deflection (θ2) of the second beam, passing through the second lens arrangement, so as to generate an interference pattern suitable for forming a holographic element.

6. An optical device according to claim 5, comprising:
a beam splitter for splitting an incident beam into first and second beams;
a first lens arrangement, located intermediate the beam splitter and a first mirror, through which first lens arrangement the first beam passes, the first mirror being arranged to reflect the first beam to the beam splitter; and
a second lens arrangement, located intermediate the beam splitter and a second mirror, through which second lens arrangement the second beam passes, the second mirror arranged to reflect the second beam to the beam splitter.

7. An optical device according to claim 6 wherein:
the first lens arrangement has two lenses and the second lens arrangement has a single lenses.

8. An optical device according to claim 1 comprising:
a beam splitter for splitting an incident beam into first and second beams; a first lens arrangement, located intermediate the beam splitter and a first mirror, through which first lens arrangement the first beam passes, the first mirror being arranged to reflect the first beam to the beam splitter; and a second lens arrangement, located intermediate the beam splitter and a second mirror, through which second lens arrangement the second beam passes, the second mirror arranged to reflect the second beam to the beam splitter.

9. An optical device according to claim 8 wherein:
the first lens arrangement has a single lens and the second lens arrangement has a single lens.

10. An optical device according to claim 1, further comprising:
an image reduction system located so as reduce the area of the interference pattern.

11. An optical device according to claim 10 wherein
the image reduction system is located between the point at which the two output beams converge and the point at which the holographic image is to be recorded.

12. An optical device according to claim 1, further comprising:
a mask is provided at an output plane, said mask being dimensioned to define an aperture for forming a shaped pixel.

13. An optical device according to claim 12 wherein:
the mask is oriented perpendicular with respect to a principal optical axis.

14. An optical device according to claim 12 wherein:
the mask is shaped to define a tessellating shaped aperture.

15. An optical device according to claim 12 wherein the mask includes
a sequentially varying mask means, which varying mask means is addressable in order to alter the shape and/or dimensions of the mask.

16. An optical device according to claim 15 wherein
the sequentially varying mask means is a ferroelectric device.

17. An optical device according to claim 15 wherein
the sequentially varying mask means is a spatial light modulator (SLM).

18. An optical device according to claim 12 wherein
the mask performs optical encoding of information, such as security data, into the hologram.

19. An optical device according to claim 12 wherein
the mask has two sets of substantially parallel sides which are at right angles, so as to define a rectangular shaped aperture.

20. An optical device according to claim 19 wherein
the mask has two sets of substantially parallel sides that are the same length and arranged to form a square aperture.

21. An optical device according to claim 2 wherein
the interference pattern defines a pixel size less than 30 μm×30 μm.

22. An optical device according to claim 21 wherein
the pixel size is less than 20 μm×20 μm.

23. An optical device according to claim 20 wherein
the pixel size is less than 10 μm×10 μm.

24. An optical device according to claim 1, further comprising:
an acousto-optic modulator (AOM) or galvanometric beam deflector adapted to expose in excess of 2000 pixels per second.

25. An optical device according of claim 1, further comprising:
an acousto-optic modulator (AOM) or galvanometric beam deflector adapted to expose in excess of 5000 pixels per second.

26. An optical device according to any of claim 1, further comprising:
acousto-optic modulator (AOM) or galvanometric beam deflector adapted to expose in excess of 10000 pixels per second.

27. An optical device according to claim 1, wherein:
the two beams emanate from a common laser and have identical coherence and are identically polarized.

28. A system including the device according to claim 1, further comprising:
a source of coherent radiation;
a scanner and
a controller for controlling the scanner and a substrate in which a hologram is formed.

29. A system according to claim 28, further comprising:
software for modulating the laser, operating the controller and the scanner so as to produce a hologram.

30. A system according to claim 28, further comprising: has
means to vary the diameter of the collimated beam.

31. A system according to claim 30 wherein the means to vary the diameter of the collimated beam comprises:
a reducing/enlarging lens arrangement.

32. A method of producing a holographic optical element comprising the steps of:
deflecting a single coherent and collimated beam in dependence upon a control signal to a beam splitter;
producing first and second light beams from said deflected beam;
directing said first and second beams to first and second lens arrangements, the first and second beams being capable of being displaced about a principal optical axis so that the angle of deflection of the first beam (θ1) is the same as, but opposite to, the angle of deflection as the second beam (θ2); and
causing the beams to superimpose in order to create holographic interference fringes at an output plane.

33. A method of mass producing holographic optical elements in an array comprising the steps of
deflecting a single coherent substantially collimated beam in dependence upon a control signal to a beam deflector;
producing first and second collimated beams of substantially the same path length and substantially symmetric from said deflected beam;
directing said first and second beams to first and second lens arrangements, which arrangements act as an interferometer, the first and second beams produced being capable of being displaced about a principal optical axis so that the angle of deflection of the first beam is the same as but opposite to the angle of deflection of the second beam; and
causing the beams to superimpose in order to create holographic interference fringes at a plane of a mask aperture, and
repeating said method.

34. A method of mass producing holographic optical elements in an array comprising the steps of
deflecting a single coherent substantially collimated beam in dependence upon a control signal to a beam deflector;
producing first and second collimated beams from said deflected beam; directing said first and second beams to first and second lens arrangements, which arrangements act as an interferometer, the first and second beams produced being capable of being displaced about a principal optical axis so that the angle of deflection of the first beam is the same as but opposite to the angle of deflection of the second beam; and
causing the beams to superimpose in order to create holographic interference fringes comprising simple diffraction gratings at a plane of a mask aperture, and
repeating said method.

35. (canceled)

36. A hologram produced by deflecting, a single collimated (or near collimated) coherent beam;
producing first and second collimated beams from said deflected beam, said beams being of substantially the same path length and being substantially symmetrical;
directing said first and second beams to first and second lens arrangements, the first and second lens arrangements being displaced about a principal optical axis so that the angle of deflection of the first beam is the same as, but opposite to, the angle of deflection of the second beam; and
causing the beams to interfere in order to create holographic interference fringes at an output plane.

37-43. (canceled)
